(19) United States
(12) Patent Application Publication
(10) Pub. No.: US 2005/0257186 A1
(43) Pub. Date: Nov. 17, 2005

(54) Operation system for programmable hardware

(76) Inventor: Michael Zilbershlag, Givat-Shmoel (IL)

Correspondence Address: KATTEN MUCHIN ROSENMAN LLP, 575 MADISON AVENUE, NEW YORK, NY, 10022-2585, US

(21) Appl. No.: 10/844,761

(22) Filed: May 13, 2004

(51) Int. Cl. G06F 17/50

(52) U.S. Cl. 716/18; 716/16

(57) ABSTRACT

The proposed software-controlled FPGA system and method provides an operating system which controls partial reconfiguration of hardware logic blocks having equivalent properties as a standard software operating system. Said hardware control operating system enables to adjust compatible hardware logic blocks according to current running applications and attached hardware devices. The partial configuration control is applied during the Setup phase, during the running phase of the program (i.e. On the Fly) or in real time using time sharing.

### BACKGROUND

The present invention relates to the field of programmable logic devices, and in particular to software-controlled programmable logic device. Programmable logic devices (PLDs) are a well-known type of digital integrated circuit that may be programmed by a user (e.g., a circuit designer) in order to perform specified logic functions. PLDs are becoming popular, largely because they are less expensive in relatively small quantities and require less time to implement than semi-custom and custom integrated circuits.

Traditionally, programmable-logic devices, such as Field Programmable Gate Array (FPGA) are programmed completely during the setup phase of the system, i.e. reset or boot phase. The description of the logic is read from a memory device and loaded into the FPGA. This occurs prior to any useful operation in which the FPGA performs in the system. Once the device is programmed, the same logic remains programmed until the system is shut down.

A new generation of FPGAs allows partial reconfiguration. The partial-reconfiguration mechanism was developed as a fault-tolerance mechanism for satellites and other spacecraft, in which memory and programmable-logic devices are susceptible to errors due to radiation. Said partial reconfiguration allows parts of the device to be shut down, reprogrammed, all while the rest of the device continues to work. Therefore, when an error in part of the device is detected by the mechanism, said device is shut down and re-programmed. The function it provides is then performed by another part of the device if the system is redundant or is temporarily suspended.

The primary goal in new techniques for software-control of partial reconfiguration is utilization of limited resources. The system reconfigures the device with new functionality when software senses that the new functionality is needed. The system removes logic from the device when that logic is no longer needed in said system, in order to make room for additional functionality. In some cases, this reconfiguration occurs rapidly and cyclically in order to provide the illusion of multiple devices, much in the same way that conventional operating system switch the processor between contexts to give users the illusion that multiple programs execute concurrently. The system also supports functions that can be performed by either programmable logic or by software. When there is space in the device, the system programs the required logic into the device, thus enabling the scenario in which the function is performed by hardware at high speed and low energy consumption. Software performs said function when there is not enough space in the device to program the needed logic. In this case, the function requires more energy and is carried out more slowly, but it ensures the case that it is still carried out.

FPGAs that support partial reconfiguration, e.g Xilinx's Virtex FPGA, are organized in columns. A mechanism called Internal Configuration Access Port (ICAP) enables to suspend the operation of a column, download a new logic block into it and restart it again with the new logic, all while other columns continue to work normally. In other words, a column is the atomic unit of reconfiguration. When a column is reprogrammed, it can serve no useful purpose, but it is not affected by the reprogramming of other columns.

Numerous attempts have been made in recent years in the partial reconfiguration environment. One example is U.S. Pat. No. 6,507,211, which discloses a Programmable Logic Device (PLD). The PLD preserves the data stored in the user storage element as said device is reconfigured to perform a new logic function, thus ensuring the state data derived from previous performed logical operations is available for use.

However, none of the existing methodologies propose a software-controlled programmable logic system and method providing partial reconfiguration of hardware logic blocks

It is thus the prime object of the invention to accomplish an innovative software-controlled FPGA system in order to provide an operating system which controls partial reconfiguration of hardware logic blocks having equivalent properties as a standard software operating system.

### SUMMARY

The present invention introduces an innovative software-controlled FPGA system and method. The system according to the present invention provides an operating system which controls partial reconfiguration of hardware logic blocks implemented within a computerized system. Said operating system is provided to enable a replacement and reconfiguration of the hardware logic blocks according to identified hardware components, which are connected to computerized systems and designated software applications on the system. The partial configuration control is applied during the Setup phase, wherein the user can determine the designated hardware application, during the running phase of the program (i.e. On the Fly) or in real time utilizing time sharing approach.

The proposed operating system provides equivalent properties included in standard software operating systems, such as Plug & Play functionality for enabling configuration and initialization of the logic blocks in accordance of detected external hardware devices, Column Manager which manages to disregard the part of the FPGA in which an improper logic element is manufactured, Cache management for enabling switching of logic blocks from the RAM, Dynamic Configuration Manager for enabling configuration of logic blocks according to current running applications and a Dynamic Link Hardware (DLH) mechanism for dynamically connecting between the hardware logic blocks and current running applications, whereas said DLH mechanism is equivalent to DLL applied in software applications.

The operating system further comprises a Buffer Descriptor including information regarding the actual hardware logic blocks currently in use by the system, wherein said Buffer Descriptor is implemented as a two dimensional linked list which is based on a predefined design tree, a Module Driver for communicating with the hardware components and a dual-ported RAM that is connected to the Internal Configuration Access Port (ICAP), thus enabling logic blocks to be stored and programmed into the FPGA continuously. An API for mapping virtual addresses of FPGA logic blocks provides flexible management of hardware logic blocks regardless of their physical location in the FPGA. The mapping procedure involves a matrix, wherein said matrix is provided to correlate between the column and the interrupt/chip-select. A Hardware-Synthesis module is a software module which enables to synthesize required logic blocks with existing logic modules as well as synthesize multiple logic blocks to a single block functioning as a co-processor. A Column Assembly software module is included for assembling logic blocks into large blocks that spread upon one or more columns by identifying the logic block's functionality in the column and organizing the logic blocks within the columns. A Design Tree Parser module is provided for managing design trees, which represent various organization structures of logic blocks in accordance to the different hardware identification and installation processes. A Protocol-Stack Device Driver module for managing stacks of logic blocks is included, wherein each stack is associated to a particular protocol stream enabling data transactions between different media components. A Flexible Device Driver is included for loading/unloading appropriate hardware logic blocks into the FPGA having equivalent functionality in software module, for dynamically reacting to the FPGA's environment and for shifting between a hardware implementation to a software equivalent implementation during operation. An Access Bus is included for identifying a data-cross connection/disconnection of any hardware devices associated with the system. A Protocol Decision Agent is further provided for sensing the external environment and selecting between the logic blocks to be loaded/removed from the system using partial reconfiguration. Said agent can identify the relevant protocol in a remotely connected system.

### BRIEF DESCRIPTION OF THE DRAWINGS

These and further features and advantages of the invention will become more clearly understood in the light of the ensuing descriptions of the preferred embodiments thereof, given by way of example only, with reference to the accompanying drawings, wherein—

FIG. 1 is an illustration of the system's software components.

FIG. 2 is an illustration of the system's hardware components.

FIG. 3 is an illustration describing the function of the Design Tree Parser through three different examples.

FIG. 4 is an illustration describing the implementation of Plug & Play in Multimedia applications.

FIG. 5 is an illustration describing the implementation of Plug & Play in Network applications.

FIG. 6 is an illustration describing the implementation of a Dynamic Configuration Manager in Multimedia applications.

FIG. 7 is an illustration describing the implementation of a Dynamic Configuration Manager in Network applications.

### DETAILED DESCRIPTION OF THE PREFERED EMBODIMENT

The system according to the present invention provides an operating system which controls partial reconfiguration of hardware logic blocks during the Setup phase, during the running phase of the program (i.e. On the Fly) or in real time using time sharing.

At the Setup phase, which is accomplished only at reset or boot phase, this software-controlled FPGA is assembled on partial reconfiguration logic blocks as well logic blocks that don't support such configuration. The main advantage resulting from the included operating system is providing the end user with the ability to configure the FPGA. A further advantage is that said operating system disregards damaged sectors in the logic blocks, therefore improving the yield of the FPGA and reducing its price. In addition, enabling to dynamically load hardware logic blocks at this phase enables logic blocks to communicate with software applications as done in operating systems that simplify the reuse of the FPGA for different applications.

The advantages of applying said software-controlled FPGA On-the-Fly involves partial reconfiguration of required hardware logic blocks only, while the remaining logic blocks continue to function. Achieving a software-controlled FPGA during the running phase of the program enables the end user to configure only part of the FPGA while remaining applications continue to run. Due to the modularity of the operating system, the end user can upgrade a specific design module in the logic block only using an independent third party. Said upgrade can be applied without the need of the manufacturer or the user to update the software inside the FPGA. At this phase, the Plug & Play property is implemented, thus enabling to detect a new functionality according to the environment's needs and to adjust the hardware applications in accordance with the new functionality. In addition, the operating system can simulate a virtual FPGA for more than one user, whereas each user uses different FPGA logic and controls an operating system of its own.

Applying said software-controlled in Real Time provides continuous and fast programming of logic blocks in evolutionary operating Systems. By accelerating the switching operation between these logic blocks using Time Sharing, multiple hardware applications can be performed in the FPGA.

The proposed system comprises of both hardware and software components. Throughout the description, the term “FPGA” is used when referring to reconfigurable hardware, although other implemented technologies may be used. This hardware control operating system enables to adjust compatible hardware logic blocks according to current running applications and attached hardware devices. Additionally, such a system enables to optimize the computerized device operation by utilization of appropriate hardware logic blocks.

The proposed operating system provides equivalent properties included in standard software operating systems, such as dynamic configuration, fault-tolerance mechanism, Plug & Play, Column Manager, Cache and DHL handling. Although the concept is equivalent, the implementations of these properties are different and are required to provide unique hardware management as will be further specified below.

Virtual address is defined to provide an additional interface over the physical position of logic blocks and to enable control of the reconfigurable logic blocks. For allowing the logic blocks to be physically moved within the columns of the FPGA a common bus is provided. Said bus connects between the hardware components by transmitting an interrupt signal to the physical location of the logic block and mapping the physical address to the virtual address. Hence, defining a virtual address enables to achieve maximum flexibility and an efficient hardware management.

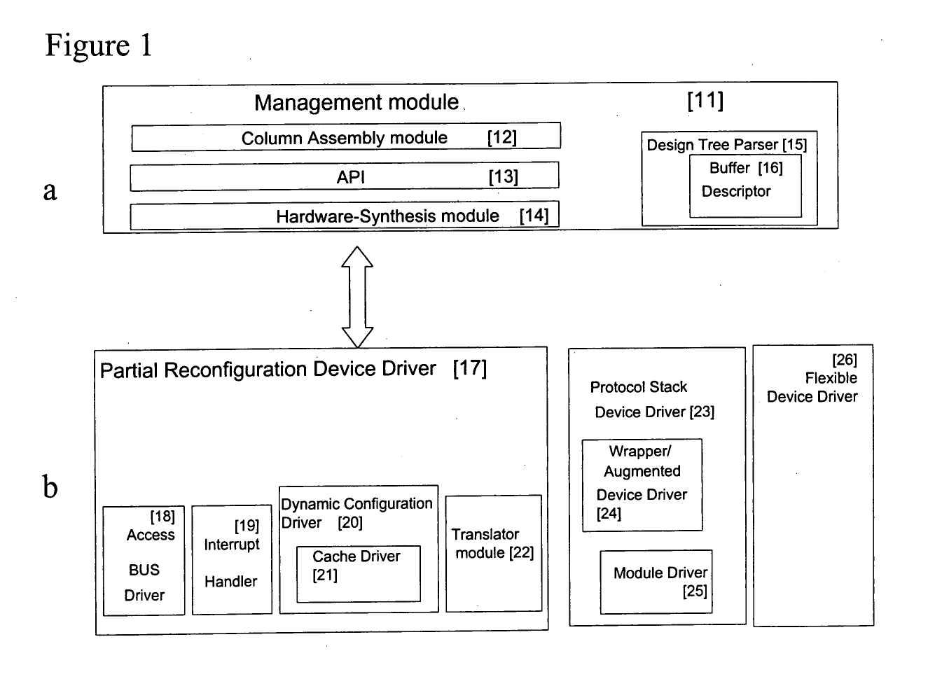

A management software module [11] (see FIG. 1), which functions as an operating system manager is provided in order to connect between the current running applications and the associated devices drivers. This module includes the following properties:
1. Plug & Play—This module enables to detect a new functionality according to the environment's needs and to provide reconfiguration and initialization of hardware logic blocks in accordance with the new functionality.
2. Dynamic Configuration Manager—This module is able to identify the dynamic environment according to running applications and attached hardware devices and to adjust compatible hardware logic blocks in Real Time (RT). In addition, this module provides the end user with the ability to configure hardware logic blocks, thus enabling a partial upgrade of the system's hardware modules.
3. Column Manager—This module manages to disregard the part of the FPGA in which an improper logic element is manufactured, thus improving the FPGA yield. In addition, when different user applications use the FPGA simultaneously, the Column Manager module allocates each user a virtual FPGA structure.
4. Dynamic Link Hardware (DLH)—This module enables hardware logic blocks to connect to and communicate with software applications as well as to ensure an efficient utilization of the FPGA's resources, as done in operating systems. Running an application involves loading the appropriate logic block and the associate driver. On the contrary, quitting an application involves evacuating resources accordingly. The DLH module is equivalent to Dynamic Link Library (DLL) handling applied in software applications.
5. Cache module—This module provides continuous and fast programming of logic blocks by accelerating the switching operation between these blocks, which are stored in a Random Access Memory (RAM).
   The capabilities of the proposed software modules mentioned above enable hardware reduction. In addition, applications running in the system do not need to adjust appropriate drivers, since the operating system supplies the required associated drivers.

FIG. 1 is an illustration of the system's software components including an operating system and associate drivers. FIG. 1a shows the software modules which assemble the operating system. FIG. 1b is a block diagram illustrating an overall description of said drivers.

The Management module [11] is the core of the operating-system module, which manages the programmed logic blocks in the FPGA. The Management module monitors the FPGA columns by determining the placement of new blocks and keeps track of the current running application. As a result, the software is able to detect logic blocks that are not needed by any application and remove them, thus making space for other blocks. In case there is ample space, the management software can also load into the FPGA blocks that might be needed in the future. These properties are equivalent to the memory manager properties in existing operating systems, including the capabilities described above.

The Column Assembly software module [12] is responsible for assembling logic blocks into large blocks that spread upon one or more columns. This software module identifies the logic block's functionality in the column and enables to organize the logic blocks within the columns, using a specialized Application Program Interface (API), e.g. Design Tree Parser.

The Application Program Interface (API) [13] handles system calls that allow running application programs to load associated logic blocks into the FPGA and to map the addresses of these blocks into a range of virtual addresses. This allows each application program to load the appropriate hardware logic block accelerator into the FPGA and to access the hardware logic block using virtual addresses. Such a procedure enables a flexible management of hardware logic blocks regardless of their physical location in the memory. Once the hardware logic block is loaded into the FPGA and mapped into the application memory, the application can use the hardware logic block directly without any operating-system involvement, thus avoiding overhead processing. This facility allows applications to utilize application-specific hardware, such as image or video processing hardware, signal processing hardware, high-precision arithmetic hardware, and so on.

The Hardware-Synthesis module [14] is a software module used for cases in which the system requires a wide variability of readymade logic blocks. This software enables to synthesize required logic blocks from existing logic modules instead of preparing all the possible blocks ahead of time and storing them in memory. For example, in a case an Arithmetic Unit is composed from a variety of logic blocks implemented in hardware. When a new application invokes a Dynamic Loader mechanism call the entire logic blocks comprising said Arithmetic Unit are required. The Hardware-Synthesis module is provided to synthesize these logic blocks to a single logic block which functions as a Co-Processor. The sole limitation required from the implementation of the logic blocks composing the Arithmetic Unit is that their input and output inter-connection is done through the processor's internal registers. Hence, the need for an internal hardware inter-connection interface is substantially reduced.

The Design Tree Parser [15] module manages the Column Assembly module [12] based on the structured data files that are produced using a graphical user interface (GUI). These structured data files are called design trees, whereas they describe various ways in which logic blocks can be assembled within the functioning columns. The design tree represents a pre-design logic process of selecting the proper logic blocks in accordance with the hardware identification process. Amongst the possibilities of controlling said design structure is from the API.

The Buffer Descriptor [16] specifies the actual hardware logic blocks currently in use by the system. Said Buffer descriptor is implemented as a two dimensional linked list which is based on a predefined design tree. The vertical dimension of the linked list represents the hardware alternatives, i.e. different protocol stream. The horizontal dimensioned linked list contains the logic blocks of the appropriate protocol stream. Each protocol stream is connected to a BUS which is designated for data cross-connection, e.g. Open Core Protocol (OCP) base BUS. When a hardware device is not active or not required, the Management module removes the associate logic from the FPGA and deletes it from the buffer descriptor as well using the Management Software module, the partial-reconfiguration driver and the ICAP.

The Partial-Reconfiguration Device Driver [17] can load and remove a logic design (block) into a given location in the FPGA. This driver controls the ICAP (see FIG. 1) that is built into the FPGA, the column-virtualization matrix and the block cache.

An Access Bus [18], Interrupt handler [19], Dynamic Configuration [20] and Cache are the compatible drivers provided for controlling the hardware modules.

The Protocol-Stack Device Drivers module [23] manages stacks of logic blocks, wherein each stack is associated to a particular protocol stream. A stack may include only a line-card block and a protocol block which delivers packets through the processor or memory, e.g. SONET block. If the stack includes appropriate logic blocks enabling stand alone functionality, no data transaction through the processor or memory are required at all. For example, a stack might include the following logic blocks for an application that transfers movies data from DV tapes to DVD media: a FireWire block followed by a DV decoder, an MPEG-2 encoder and a DVD-R burner. The Stack Device module is responsible for setting up the stack, for managing the hardware connections between the logic blocks and for using protocol agents to reconfigure the stack when needed. This module also notifies the management module [11] of changes in hardware configuration and current running applications in order to enable the logic blocks to adapt to the environment's needs. This procedure is equivalent to the hot-plug mechanism behavior in Linux and to some plug-and-play devices in Windows.

The FPGA's Module Driver [25] is handled by the system's running applications in order to communicate with the hardware components, thus enabling to dynamically load hardware logic blocks into current running applications. A type of Module Driver used in the proposed system is the Wrapper Device Driver.

The Wrapper Device Driver [24] is used in the proposed system when a logic block is associated to a closed-source device driver, e.g. object code. This wrapper device detects the presence of existing hardware devices, initializes it by loading appropriate logic into the FPGA and removes it using the management software and the partial-reconfiguration driver. Said operations are provided according to pre-defined design tree logic, e.g. a single block or an arbitrary assembly.

The Augmented Device Driver [24] is used in the proposed system when a logic block is associated to an open-source device driver. The modification routine of said device driver by the management software and partial-reconfiguration driver involves initialization according to software according to software that loads the logic into the FPGA and removal according to software that removes the logic. Again the actual insertion and removal of the logic will be done by the management software and by the partial-reconfiguration driver.

The Flexible Device Driver [26] is provided to enable loading the appropriate hardware logic blocks into the FPGA or to perform the same function in software. The latter is done in cases where there is not enough space in the FPGA. In addition, this device driver can react to the FPGA's environment and shift from a hardware implementation to a software one during operation. An example might be a coder for a variable-bit-rate compression scheme, such as MPEG-2. The device driver can use a hardware coder when there is space in the FPGA. During said scenario, the driver feeds the hardware with uncompressed data and consumes the compressed stream. When the FPGA is full the driver shifts to use software implementation thus enabling real-time coding. Although using software implementations involves slowing down the total process and harming the quality of service is harmed, the driver can still provide the service even without hardware.

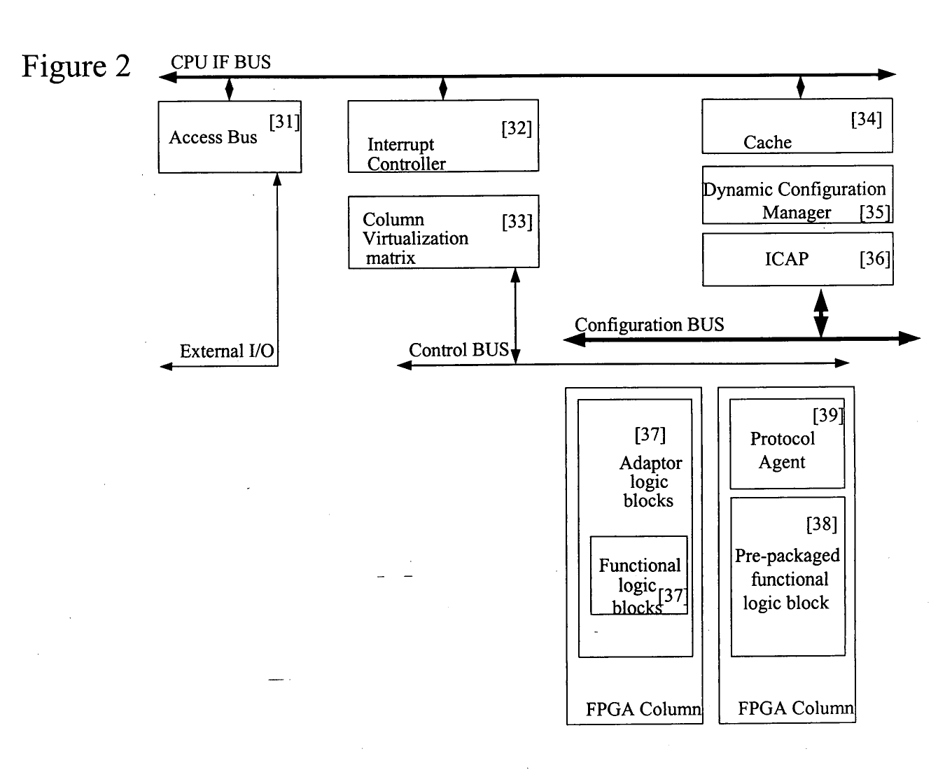

FIG. 2 is an illustration of the system's hardware components including a processor (CPU), common bus and associated memory devices in accordance with the present invention. These devices are usually permanent and are operating in corporation with the software module.

The Access Bus [31] enables identifying a data cross connection/disconnection of any hardware devices associated with the system. On the basis of this detection, the logic blocks are programmed into the columns of the FPGA and initialized according to the new required functionality.

The Interrupt Controller [32] feed the processor a device interrupts. Said interrupt being a signal informing the program that an event has occurred, thus ensuring the program takes on a specified action in order to service this interrupt.

The Column-virtualization matrix [33] component is usually programmed into the FPGA, although it can be a specialized hardware component as well. This component is responsible for mapping the logical chip-select and interrupt signals into the appropriate column in the FPGA. When our system decides to program a hardware block column with a particular device, it assigns the block a column, as well as an interrupt channel and chip-select, which are presented as a range of addresses. The mapping between the column and the interrupt/chip-select is programmed into the matrix. Said scenario enables the associate hardware logic block to receive a chip-select signal when the processor sends the chip-select request on the Address Bus [31]. Said signal comprises of the Most Significant Bits (MSB), which determines the address of the associate logic blocks, and the Least Significant Bits (LSB), which serves these logic blocks. When the hardware sends an interrupt signal, it is routed to the processor on the appropriate interrupt channel. This component enables the logic blocks to be physically transferred within the columns while avoiding unnecessary reconfiguration of device drivers, since the drivers use the logical interrupt/chip-select virtual addresses. This matrix is equivalent to the Translation Look-aside Buffer (TLB) table applied in software applications.

The Cache [34] is an optional hardware component unique to the proposed system. It consists of a dual-ported Random Access Memory (RAM) that is connected to the Internal Configuration Access Port (ICAP). The main advantage of this component lies in designating a plurality of logic blocks to a specific physical address. This component enables logic blocks to be stored by the processor in the dual-ported RAM, thus programmed into the FPGA continuously and much faster. Storing said devices in the Cache accelerates the switching operation between them.

The Dynamic Configuration Manager [35] is provided to enable the identification of the environment and to adjust compatible hardware logic blocks in Real Time (RT) according to running applications and attached hardware devices.

The Internal Configuration Access Port (ICAP) [36] is the FPGA's programming mechanism, which is structured to enable reconfiguration of logic blocks according to the environment's needs. This mechanism is programmed to suspend the operation of a particular column, download a new logic block into it and restart the operation of said protocol stream again with the new logic—all while adjacent columns continue to work normally.

Adaptor Logic Blocks [37] allow the proposed system to use existing off-the-shelf functional blocks into the running system. These adaptor blocks enable functional logic blocks to be stored in stacks and programmed within the FPGA's columns.

Pre-packaged functional logic blocks [38] can be either off-the-shelf blocks or blocks designed for a particular application.

The Protocol Decision Agent [39] is provided to sense the external environment and select between the logic blocks, which are loaded/removed from the system using partial reconfiguration. These decision agents identify the relevant protocol in order to allow the system to reconfigure itself dynamically thus enabling the system to adapt to changes in a remotely connected system completely automatically. The partial reconfiguration is accomplished using a Design Tree Parser, which manages a Design Tree.

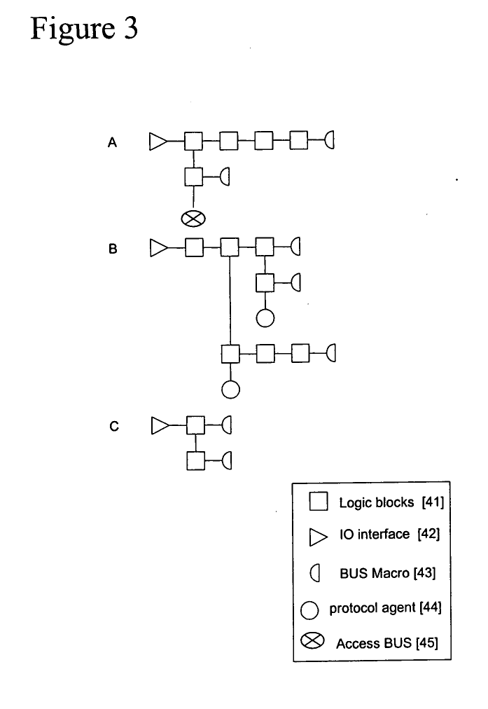

FIG. 3 is an illustration describing the function of the Design Tree Parser through three different examples. The Protocol Decision Agent [44] selects the logic blocks, which are loaded/removed from the system using partial reconfiguration. These decision agents sense the external environment in order to allow the system to reconfigure itself intelligently. The partial reconfiguration is accomplished using a Design Tree Parser, which manages a Design Tree. Said Design Tree is configured in advance by the engineer and is provided to describe the various possibilities in which the logic blocks can be assembled within the columns. User-level programs can assemble the columns by simply naming a design tree, sparing the need of using the column-assembly API [15] directly.
In FIG. 3a, the Input/Output (IO) interface [42] is connected to two different protocol streams, said protocols streams comprised of different logic blocks [41]. An Access Bus [45] is provided for identifying the hardware devices and for selecting between said protocol streams. A BUS Macro [43] connects the last module of each protocol stream to the generic bus.
In FIG. 3b, the IO interface [42] is connected to a single logic block. Two Protocol Decision Agents [44] are applied for selecting between the protocol streams by using an interrupt. For example, suppose an external communication channel is connected to a SONET block in the FPGA. When the system's software discovers that the SONET block is generating mostly errors and no useful data, a protocol agent is activated and used for detecting the new protocol on that channel, e.g. Gigabit Ethernet. The SONET block and the protocol agent block are then removed and a Gigabit Ethernet block is loaded and connected to the channel.
In FIG. 3c, the IO interface [42] is connected to two different logic blocks, wherein no Protocol Decision Agent is applied for the selection. In this case, the Buffer Descriptor stores both logic blocks sharing the same IO interface. The Dynamic Configuration Manager is responsible of selecting the actual active logic block required by the application.

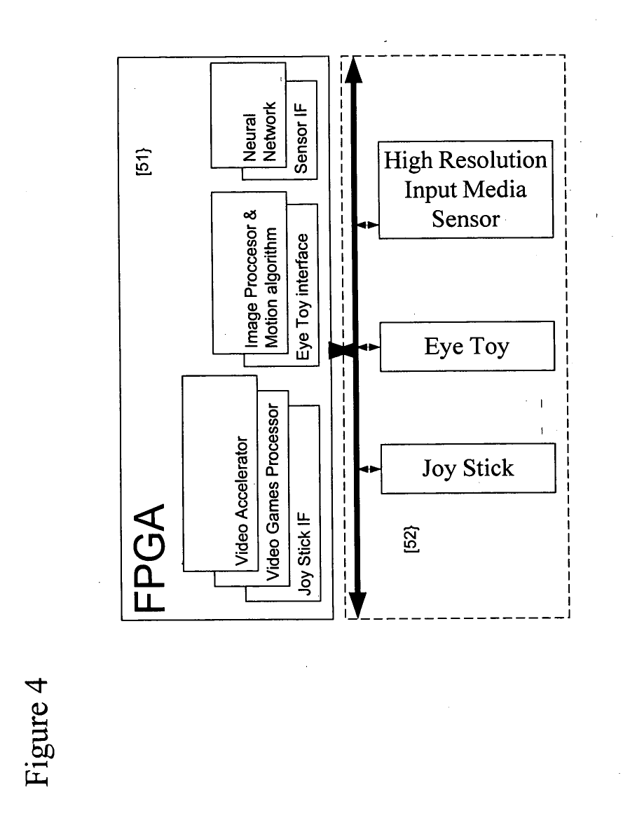

FIG. 4 is an illustration describing the implementation of Plug & Play in Multimedia applications. The main advantage of the Plug & Play attribute is reflected in the ability to add and reconfigure complex external devices [52] (peripherals, board cards, etc.) and internal [51] hardware components, wherein the internal hardware support the external devices. A domestic multimedia system identifies the hardware interface enabling flexibility coordination between the external hardware modules. For example, connecting Sony's Eye Tone digital camera to a standard interface with no image processing involves a limited camera for simple games. In contrast, connecting a video camera enables to load image processing modules and automatic movement detection of more complex computer games. Since the digital hardware is implemented within the FPGA and the operating system supplies the required hardware, current applications running in the system do not need to develop appropriate drivers. Hence, the external interface is significantly cheaper and less complex.

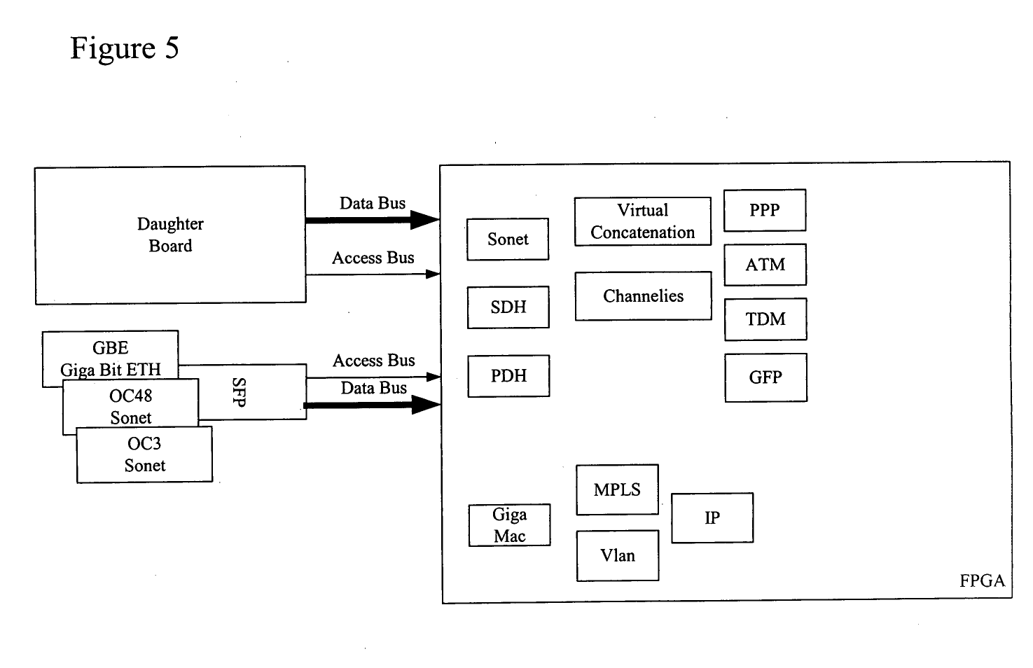

FIG. 5 is an illustration describing the implementation of Plug & Play in Network applications. This illustration is a network system serving various network interfaces, said interfaces including seven-layers of associated protocols. Plug & Play implementation in network systems is capable of identifying the interface, match coordinate hardware modules and develop an All-to-All system. An all-to-All system provides switching and processing of all seven layers and associated protocols. The proposed network structure is analog to a dual stack in a regular operating system and enables a modular assembly of hardware.

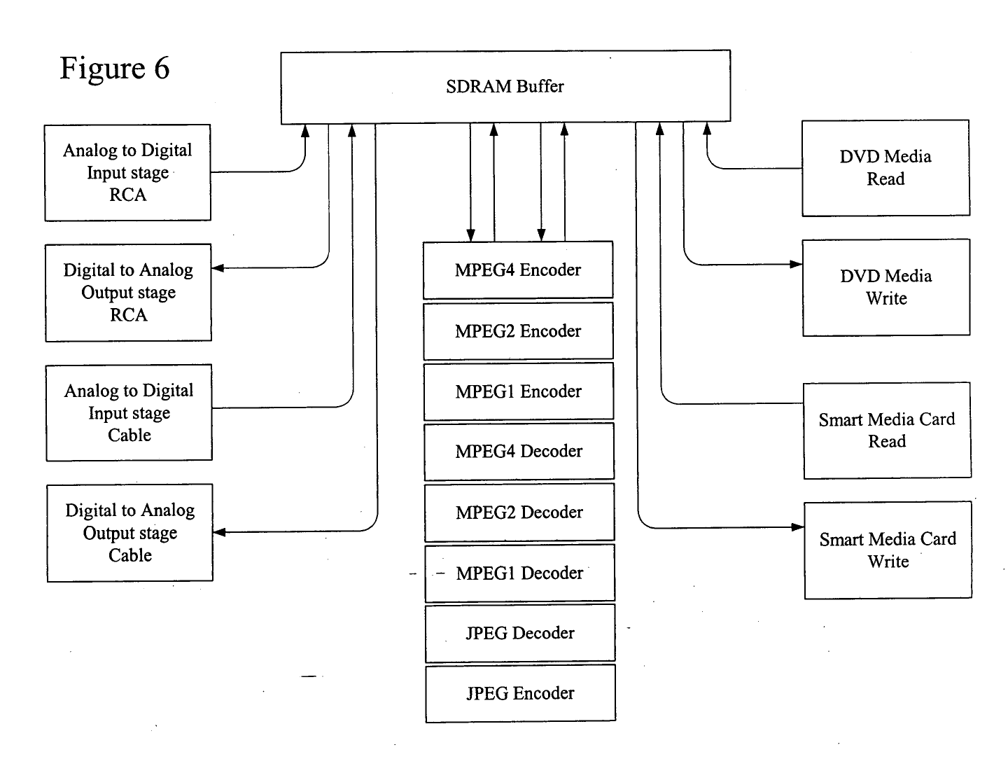

FIG. 6 is an illustration describing the implementation of a Dynamic Configuration Manager in Multimedia applications. Multimedia applications are characterized by their need of complex image processing and their low sensitivity to time delay. The proposed implementation accomplishes numeral multimedia tasks simultaneously, since the replacement time of hardware devices is negligible to the process time. Said implementation includes a Digital Versatile Disk (DVD) Recorder and an analog converter for domestic multimedia usage. The system can be designated, for example, to record a particular channel to a DVD or CD or to transmit a DVD to a Resource Complex—A (RCA). In addition, the system enables to watch a movie while saving some pictures in the memory, to burn a movie on a DVD while watching a different movie, to record one movie while watching another or to convert a DVD movie to a DVx movie. Hence, the Dynamic Configuration Manager spares the need of multiple hardware devices for a simultaneous decoding and encoding, since all the devices are virtually connected, stored in the RAM and replaced among them-selves using time sharing.

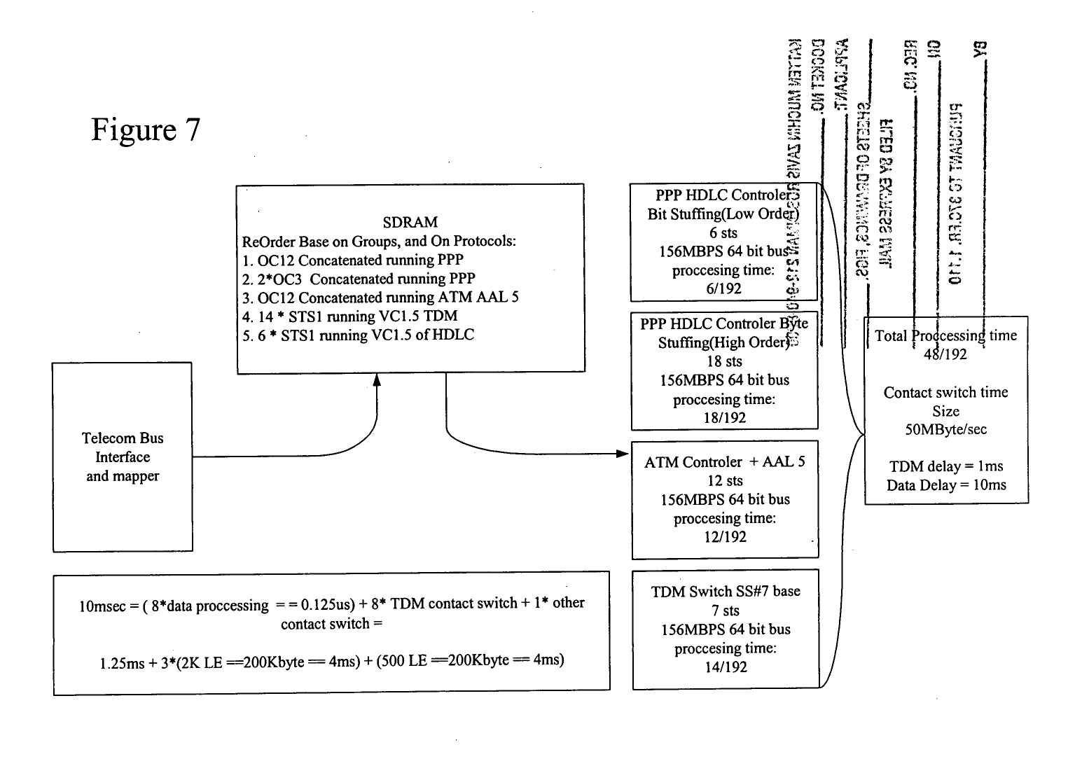

FIG. 7 is an illustration describing the implementation of a Dynamic Configuration Manager in Network applications. The proposed implementation is a network system serving various network channels and associated protocols are arriving from various sources. Since TDM cross-connect is capable of handling SONET data streams, information regarding a different mapping appears every clock cycle. The Dynamic Configuration Manager enables to process multiple protocol tasks while keeping up with the system's requirements and gaining a substantial hardware reduction. Eventually, a FPGA programmable-logic device capable of overcoming its sensitivity to delay time will be implemented. When this occurs, much greater complex processing and switching in network systems can be performed.

1. An operating system for management of partial reconfigurable hardware logic blocks implemented within a computerized system enabling to replace and reconfigure the hardware logic blocks according to identified hardware components connected to computerized systems and designated software applications on the system.

2. The operating system of claim 1 wherein the Partial reconfiguration of hardware logic blocks is done during the Setup phase wherein the user can determine the designated software application.

3. The operating system of claim 1 wherein the Partial reconfiguration is enabled through computerized system operation (“on the fly”), wherein the designated hardware application is the current running application.

4. The operating system of claim 1 wherein the management of Partial reconfiguration of hardware logic blocks is done in Real Time utilizing time sharing mechanism.

5. The operating system according to claim 3 and 4 including plug & play functionality by enabling configuration and initialization of the logic blocks in accordance of detected external hardware devices.

6. The operating system according to claims 2, 3 and 4 including Dynamic Configuration Manager for enabling configuration of logic blocks adapted to current running application.

7. The operating system according to claim 3 and 4 further including a Management module for managing the programmed logic blocks in the FPGA, wherein the management include assignment of new blocks and tracking current running application for detecting logic blocks that are not needed by any application and removing them.

8. The operating system according to claim 7 wherein the management module include a Buffer Descriptor which include information of actual hardware logic blocks currently in use by the system.

9. The operating system according to claim 2, 3 and 4 further including a DLH module for enabling hardware logic blocks to connect to and communicate with software applications.

10. The operating system according to claim 9 further including Module Driver for communicating with hardware components.

11. The operating system according to claim 3 and 4 including Cache management enabling switching of logic blocks from the Random Access Memory (RAM).

12. The operating system of claim 11 further comprising a dual-ported Random Access Memory (RAM) that is connected to the Internal Configuration Access Port (ICAP), enabling logic blocks to be stored by the processor in the dual-ported RAM and programmed into the FPGA continuously.

13. The operating system according to claim 2 and 3 further including a Column Manager module enabling to disregard improper logic blocks of the FPGA.

14. The operating system according to claim 2, 3 and 4 further including an API for mapping virtual addresses of FPGA logic blocks enabling flexible management of hardware logic blocks regardless of their physical location in the FPGA.

15. The operating system according to claim 14 wherein the mapping include matrix correlation between the column and the interrupt/chip-select, whereas said matrix correlation is equivalent to the TLB table applied in software applications.

16. The operating system according to claim 2, 3 and 4 further including a Hardware-Synthesizer module, which is a software module, provided to synthesize required logic blocks with existing logic modules.

17. The operating system according to claim 16 wherein the Hardware-Synthesis module synthesizes multiple logic blocks as a single block which function as co-processor.

18. The operating system according to claim 3 and 4 further including a Column Assembly software module for assembling logic blocks into large blocks that spread upon one or more columns by identifying the logic block's functionality in the column and organizing the logic blocks within the columns.

19. The operating system according to claim 2, 3 and 4 further including a Design Tree Parser module for managing design trees which represent various organization structures of logic blocks in accordance with different hardware identification and installation processes.

20. The operating system according to claim 3 and 4 further including a Protocol-Stack Device Driver module for managing stacks of logic blocks, wherein each stack is associated to a particular protocol stream enabling data transactions between different media components.(

21. The operating system according to claim 3 and 4 further including a Flexible Device Driver for loading/unloading appropriate hardware logic blocks into the FPGA which performs an equivalent function of software module, dynamically reacting to the FPGA's environment and shifting between a hardware implementation to a software equivalent implementation during operation.

22. The operating system according to claim 3 and 4 further including an Access Bus for identifying a data cross connection/disconnection of any hardware devices associated with the system.

23. The operating system according to claim 3 and 4 wherein the logic block functionality can be updated automatically in accordance with hardware components' upgrading.

24. The operating system according to claim 3 and 4 further comprising a Protocol Decision Agent for sensing the external environment and selecting between the logic blocks to be loaded/removed from the system using partial reconfiguration wherein said agent can identify the relevant protocol adapted to changes in a remotely connected system.
